(19) United States
(12) Patent Application Publication
(10) Pub. No.: US 2022/0260470 A1
(43) Pub. Date: Aug. 18, 2022

(54) GUIDED WAVE RADAR INSTRUMENT FOR EMULSION MEASUREMENT

(71) Applicant: Magnetrol International, Incorporated, Aurora, IL (US)

(72) Inventors: Paul G. Janitch, Lisle, IL (US); Michael D. Flasza, South Barrington, IL (US); Steven R. Page, Naperville, IL (US); Feng Tang, Geneva, IL (US)

(73) Assignee: Magnetrol International, Incorporated, Aurora, IL (US)

(21) Appl. No.: 17/174,555

(22) Filed: Feb. 12, 2021

(51) Int. Cl. G01N 13/00

(52) U.S. Cl. CPC G01N 13/00

(57) ABSTRACT

There is disclosed a radar transmitter for emulsion measurement comprising a probe defining a transmission line for sensing impedance. A first excitation circuit is connected to a top of the probe for generating downward travelling excitation signals on the transmission line and receiving a reflected signal from the transmission line. A second excitation circuit is connected to a bottom of the probe for generating upward travelling excitation signals on the transmission line and receiving a reflected signal from the transmission line, each of the reflected signals comprising a waveform of probe impedance over time. A controller is operatively connected to the excitation circuits. The controller profiles a section of waveform from each of the excitation circuits and combines information on the sections to determine positions of layers of fluids in a tank, wherein the first excitation circuit provides information about an interface from air into a first fluid layer, and from the first layer to a second layer, and the second excitation circuit provides information about an interface between a lowest layer and the second layer.

### CROSS-REFERENCE TO RELATED APPLICATIONS

There are no related applications.

### FEDERALLY SPONSORED RESEARCH OR DEVELOPMENT

Not Applicable.

### MICROFICHE/COPYRIGHT REFERENCE

Not Applicable.

### FIELD OF THE INVENTION

This invention relates to process control instruments, and more particularly, to a guided wave radar probe for use in emulsion measurement applications.

### BACKGROUND

Process control systems require the accurate measurement of process variables. Typically, a primary element senses the value of a process variable and a transmitter develops an output having a value that varies as a function of the process variable. For example, a level transmitter includes a primary element for sensing level and a circuit for developing an electrical signal proportional to sensed level.

Knowledge of level in industrial process tanks or vessels has long been required for safe and cost-effective operation of plants. Many technologies exist for making level measurements. These include buoyancy, capacitance, ultrasonic and microwave radar, to name a few. Recent advances in micropower impulse radar (MIR), also known as ultra-wideband (UWB) radar, in conjunction with advances in equivalent time sampling (ETS), permit development of low power and low-cost time domain reflectometry (TDR) instruments.

In a TDR instrument, a very fast pulse with a rise time of 500 picoseconds, or less, is propagated down a probe that serves as a transmission line in a vessel. The pulse is reflected by a discontinuity caused by a transition between two media. For level measurement, that transition is typically where the air and the material to be measured meet. These instruments are also known as guided wave radar (GWR) measurement instruments.

One type of probe used by GWR level instruments is a coaxial probe. The coaxial probe consists of an outer tube and an inner conductor. When a coaxial probe is immersed in the liquid to be measured, there is a section of constant impedance, generally air, above the liquid surface. An impedance discontinuity is created at the level surface due to the change in dielectric constant of the liquid versus air at this point. When the GWR signal encounters any impedance discontinuity in the transmission line, part of the signal is reflected back toward the source in accordance with theory based on Maxwell's laws. The GWR instrument measures the time of flight of the electrical signal to, and back from, this reflecting point, being the liquid surface, to find the liquid level.

GWR probes are frequently used in tanks where multiple layers of fluids can exist, or in applications with highly viscous liquid. One example of such an application is in the oil and gas industry. Well fluid containing crude oil, water, sand and other impurities enters a separator tank as a mixture. This is generally illustrated in FIG. 1. The fluids stratify by way of density variations of gases on top, oil in the middle and water on the bottom. Solids will descend to the bottom of the tank or be suspended at an interface between adjacent layers. An emulsion layer made up of a mixture of water and oil occurs between the layers as the stratification process stabilizes. After a period of time, the components can be separated using weirs or other means.

The objective of the GWR probe in such applications is to accurately measure several levels, including, the top of the oil layer, the bottom of the oil layer (i.e., the top of the emulsion layer) and the top of the water layer (i.e., the bottom of the emulsion layer). There are several difficulties when using GWR measurement instruments in interface applications or with viscous fluids. GWR is commonly used to measure fluid interface levels where the dissimilar dielectric properties of adjacent layers produce a reflection from the transmitted signal at the boundary. However, interface detection becomes more difficult when a thick emulsion layer is present and the dielectric properties of the fluid changes gradually. It has been observed that a small percentage of water in oil creates a significant difference in the dielectric properties compared to oil alone. A small percentage of oil in water behaves much like water alone. Therefore, it is more difficult to discern the interface between water and an emulsion of water with a small percentage of oil compared to the interface between oil and an emulsion of oil with a small percentage of water. As such, it is more difficult to detect the bottom of the emulsion layer than the top of the emulsion layer.

U.S. Pat. No. 9,546,895, owned by Applicant herein, describes a method to go beyond time of flight, and profile impedance versus distance. That method uses a sharp-edged step instead of a narrow pulse. The method then analyzes the waveform taking into consideration the well-known relationship between impedance and wave velocity. Material properties can cause estimation errors in the upper layers which then propagate to lower layers. Also, the lower layers may comprise water mixed with a small amount of oil, so the reflected signal is very small, which means the measured emulsion has a great sensitivity to the voltage, leading to errors.

The present invention is directed to solving one or more of the problems discussed above in a novel and simple manner.

### SUMMARY

As described herein, a guided wave radar probe for use in emulsion measurement applications uses both top-down and bottom-up measurement signals.

In accordance with one aspect, a three phase guided wave radar measurement instrument for measurement of an emulsion comprises a hydrocarbon layer atop an emulsion layer of hydrocarbon and water atop a water layer. The instrument comprises a probe defining a transmission line, the probe comprising a process connection for mounting to a process vessel, an elongate rod extending downward from the process connection to extend into a process liquid, a top connector at a top end of the elongate rod, and a bottom connector at a bottom end of the elongate rod. A top excitation circuit is connected to the probe top connector for generating excitation signals on the transmission line and receiving a reflected signal from the transmission line, the reflected signal comprising a top-down waveform of probe impedance over time. A bottom excitation circuit is connected to the probe bottom connector for generating excitation signals on the transmission line and receiving a reflected signal from the transmission line, the reflected signal comprising a bottom-up waveform of probe impedance over time. A controller is operatively connected to the top excitation circuit and the bottom excitation circuit. The controller alternately operates the top excitation circuit and the bottom excitation circuit and profiles content of the emulsion responsive to analysis of the top-down and bottom-up waveforms to determine interface levels between air and the hydrocarbon layer, between the hydrocarbon layer and the emulsion layer and between the emulsion layer and water.

In accordance with another aspect, there is described a guided wave radar measurement instrument comprising a probe defining a transmission line, the probe comprising a process connection for mounting to a process vessel, an elongate rod extending downward from the process connection to extend into a process liquid, a top connector at a top end of the elongate rod, and a bottom connector at a bottom end of the elongate rod. A top excitation circuit is connected to the probe top connector for generating excitation signals on the transmission line and receiving a reflected signal from the transmission line, the reflected signal comprising a top-down waveform of probe impedance over time. A bottom excitation circuit is connected to the probe bottom connector for generating excitation signals on the transmission line and receiving a reflected signal from the transmission line, the reflected signal comprising a bottom-up waveform of probe impedance over time. A controller is connected to the top excitation circuit and the bottom excitation circuit. The controller alternately operates the top excitation circuit and the bottom excitation circuit and profiles content of the emulsion responsive to the waveforms by transforming the waveforms into impedance relative to distance, converting the transformed waveforms into effective dielectric relative to distance, determining mixture content of the emulsion at select distances responsive to the effective dielectric at the select distances and developing an output representing mixture content relative to level units.

In accordance with a further aspect, there is disclosed a radar transmitter for emulsion measurement comprising a probe defining a transmission line for sensing impedance. A first excitation circuit is connected to a top of the probe for generating downward travelling excitation signals on the transmission line and receiving a reflected signal from the transmission line. A second excitation circuit is connected to a bottom of the probe for generating upward travelling excitation signals on the transmission line and receiving a reflected signal from the transmission line, each of the reflected signals comprising a waveform of probe impedance over time. A controller is operatively connected to the excitation circuits. The controller profiles a section of waveform from each of the excitation circuits and combines information on the sections to determine positions of layers of fluids in a tank, wherein the first pulse circuit provides information about an interface from air into a first fluid layer, and from the first layer to a second layer, and the second pulse circuit provides information about an interface between a lowest layer and the second layer.

Other features and advantages will be apparent from a review of the entire specification, including the appended claims and drawings.

### BRIEF DESCRIPTION OF THE DRAWINGS

FIG. 1 is a sectional view of a process vessel including a guided wave radar (GWR) measurement instrument with a probe for measuring level in tanks with multiple layers of fluids;

FIG. 2 is a generalized view of the GWR measurement instrument used in FIG. 1;

FIG. 3 is a side elevation view of the GWR probe;

FIG. 4 is a cut away sectional view of the top of the GWR probe;

FIG. 5 is a is a cut away sectional view of the bottom of the GWR probe;

FIG. 6 is a block diagram of a measurement circuit for the GWR measurement instrument;

FIG. 7 shows a diagram of the GWR probe in a fluid tank filled with multiple material layers;

FIG. 8 comprises curves illustrating a basic simulation of lossless transmission line segments with the GWR probe;

FIG. 9 illustrates a bottom-up waveform with no sand, and a bottom-up waveform with sand;

FIG. 10 shows a waveform to illustrate a method to locate an emulsion floating on water;

FIG. 11 illustrates a circuit diagram operating to be implemented in software to determine the level of an emulsion floating on water; and

FIG. 12 is a flow diagram illustrating operation of software for determining material levels.

### DETAILED DESCRIPTION

This application describes a method which supplements the methodology disclosed in Applicant's U.S. Pat. No. 9,546,895, the specification of which is incorporated by reference herein, by providing a second signal which travels upwards through water and reflects from a layer of emulsion floating on the water.

As described more particularly below, a radar transmitter for emulsion measurement comprises a probe defining a transmission line for sensing impedance and two excitation circuits. A first excitation circuit connects to the top of the probe for generating downward travelling excitation signals on the transmission line and receiving a reflected signal from the transmission line. A second excitation circuit is connected to the bottom of the probe for generating upward travelling excitation signals on the transmission line and receiving a reflected signal from the transmission line. Each reflected signal comprises a waveform of probe impedance over time. A controller is operatively connected to the excitation circuits. The controller profiles a section of waveform from each of the two excitation circuits and combines the information to determine positions of layers of fluids in a tank. The first excitation circuit provides information about the interface from air into the first fluid layer, and from the first layer to a second layer. The second excitation circuit provides information about the interface between the lowest layer, which is typically water, and the layer above, typically an emulsion of water and the upper layers.

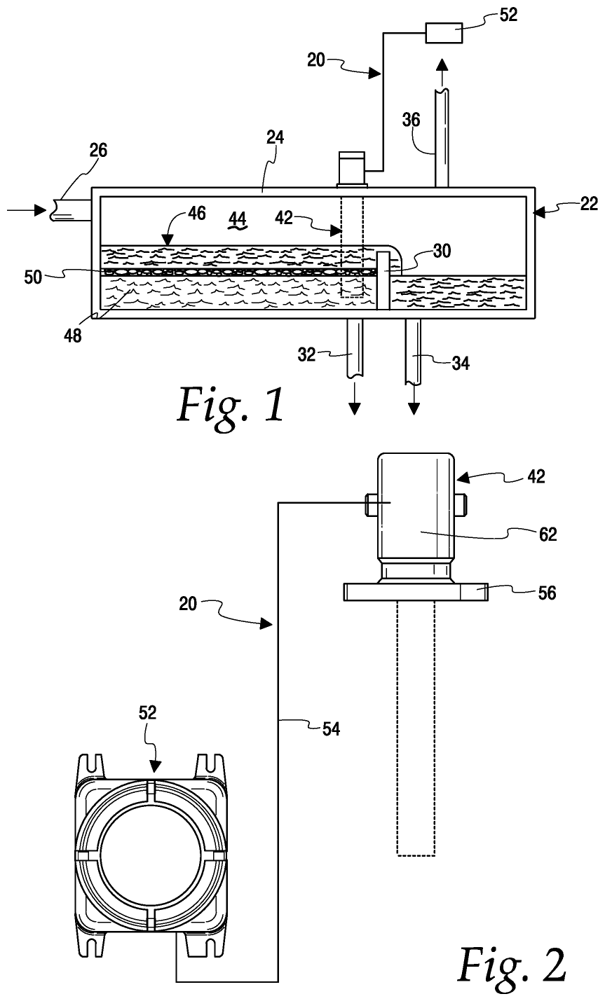

Referring initially to FIG. 1, a process instrument 20 in the form of a guided wave radar (GWR) level measurement instrument is illustrated used on a process vessel 22. The process vessel 22 is by way of example and in the illustrated embodiment comprises a separator tank 24 having an inlet 26 for receiving well fluid in-flow. The tank 24 includes a weir 30 extending upwardly from a bottom of the tank 24. A water outlet 32 is on the bottom of the tank 24 on the inlet side of the weir 30. An oil outlet 34 is on the opposite side of the weir 30. A gas outlet 36 is provided on the top of the tank 24. The process instrument 20 comprises a probe 42 extending into an interior 44 of the tank 24.

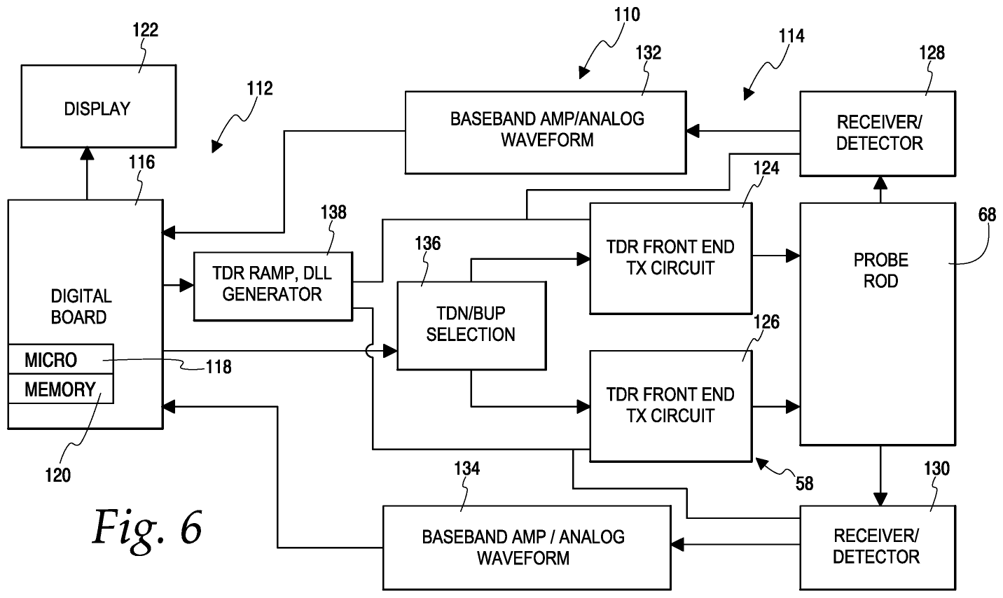

Referring to FIG. 2, the process instrument 20 includes a control housing 52, the probe 42, and a cable 54 for connecting the probe 42 to the housing 52. The probe 42 is mounted to the process vessel 22 using a process connection, such as a flange 56. Alternatively, a process adaptor could be used. The housing 52 is remote from the probe 42. The probe 42 comprises a high frequency transmission line which, when placed in a fluid, can be used to measure level of the fluid. Particularly, the probe 42 is controlled by a controller, see FIG. 6, in the housing 52 for determining level in the vessel.

As is described, the controller causes the probe 42 to generate and transmit step excitation signals. A reflected signal shows actual impedance along the transmission line.

The control circuitry of the process instrument 20 may take many different forms. This application is particularly directed to the probe 42, as described below. It should be noted in FIG. 1 and FIG. 2 the portion of the probe 42 extending into the tank 24 is illustrated in dashed lines as detail is provided in other figures.

As described previously, well fluid provided at the inlet 26 may contain crude oil, water, sand and other impurities. The fluids stratify to produce an oil layer 46 and water layer 48 separated by an emulsion 50. The water is to the left of the weir 30 in the orientation shown in FIG. 1 and can be selectively removed using the water outlet 32. Oil in the oil layer 46 at a level higher than the weir 30 can drop to the right of the weir 30 and be selectively removed using the oil outlet 34 as is conventional. The process instrument 20 is particularly adapted to measure the various interfaces including the top of the oil layer 46, the bottom of the oil layer 46, and the top of the water layer 48.

The process instrument 20 uses stepped radar in conjunction with equivalent time sampling (ETS) and ultra-wide band (UWB) transceivers for measuring level using time domain reflectometry (TDR). Particularly, the instrument 20 uses guided wave radar for sensing level. While the embodiment described herein relates to a guided wave radar level sensing apparatus, various aspects of the invention may be used with other types of process instruments for measuring various process parameters.

The probe 42 is able to transmit and receive excitation signals from both ends when used in connection with a signal circuit having two TDR circuits. A “top-down” circuit sends a signal down the probe 42 from the top and detects signals that are reflected back to the top. A “bottom-up” circuit sends a signal up the probe 42 from the bottom and detects signals that are reflected back to the bottom. The ability to transmit from the bottom-up has the advantage of improved detection of the emulsion layer bottom. Such a system is described in Applicant's co-pending application Ser. No. 16/278,368, filed Feb. 18, 2019, the specification of which is incorporated by reference herein. As described below, the transmission cable for the bottom-up transmission line runs through one of the ground rods, which is tubular.

The probe 42 may be as described in Applicant's application Ser. No. 16/507,672, filed Jul. 10, 2019, the specification of which is incorporated by reference herein. The probe 42 has a center rod which may be of stainless steel or other metal. Nickel alloys, such as Hastelloy or Inconel, may be used for corrosion resistance. The rod has PFA sleeve. Other fluorocarbon materials, such as PTFE, or other electrical insulating coatings may be used. The purpose is to allow maximum signal penetration through the process as described in Applicant's U.S. Pat. No. 9,360,361.

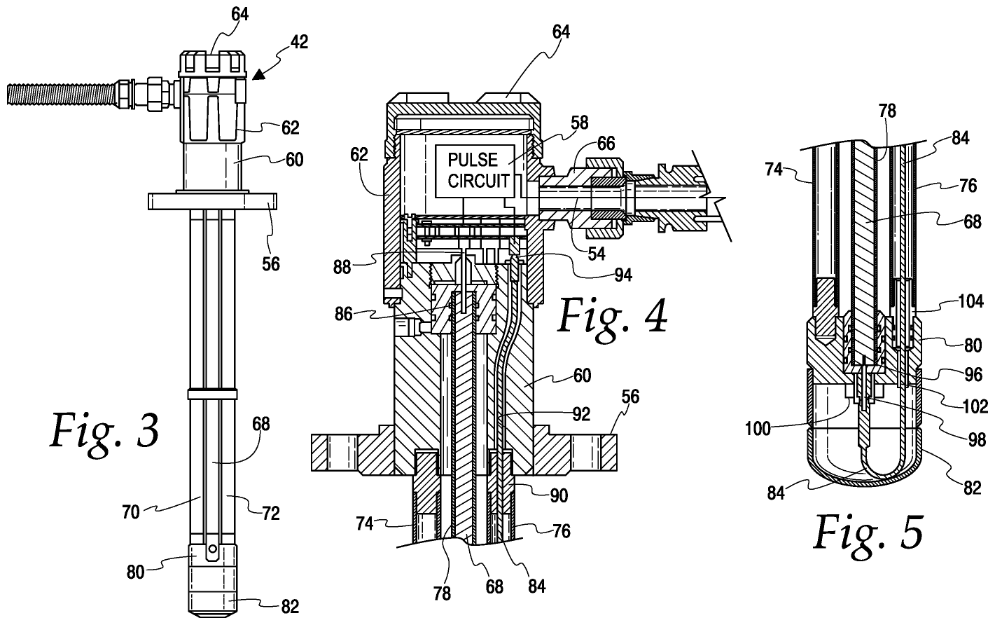

Referring to FIGS. 3-5, and as described in greater detail in the application incorporated by reference herein, the probe 42 comprises a probe case 60 connected to the flange 56 such as by welding. A top housing 62 is connected to the probe case 60 and houses a pulse circuit 58 and is closed by a top cover 64. The top housing 62 includes a threaded side adapter 66 for receiving the cable 54, see FIG. 2. Secured to and extending downwardly from the probe case 60 are a center rod 68, defining the transmission line, surrounded by four equally, angularly spaced ground rods 70, 72, 74 and 76. The length of the center rod 66 and ground rods 70, 72, 74 and 76 are dependent on the height of the vessel 22 and the level to be measured. The center rod 68 is a metal rod with a PFA outer sleeve 78. Other materials may be used, as discussed above. A bottom case 80 is connected at a bottom end of the ground rods 70, 72, 74 and 76 and is connected to a bottom enclosure 82. The center rod 68 is mounted to the probe case 60 using a seal adapter 86 and is electrically connected via a terminal 88 to the pulse circuit 58.

The ground rods 70, 72, 74 and 76 are metal tubes, such as stainless-steel or the like, connected to the probe case 60. The fourth ground rod 76 is adapted for carrying a coaxial cable 84 used for bottom-up measurement. The ground rod 76 is secured as by welding to a cylindrical connector 90 connected to the probe case 60 in alignment with a passage 92 in communication with the probe housing 62 and is electrically connected via a terminal 94 to the pulse circuit 58.

The bottom case 80 is cylindrical and of stainless-steel and receives a PTFE gland bushing 96 which captures a bottom end of the center rod 68. A pin 98 is connected at one end to the center rod 68 and at the opposite end to a coax connector 100 connected to a bottom end of the cable 84. The cable 84 passes through a vertical opening 102 in the bottom probe case 80 which receives a cylindrical adapter 104 for connecting the fourth ground rod 76 to the probe bottom case 80.

Referring to FIG. 6, electronic circuitry mounted in the control housing 52 and the probe housing 62 of FIG. 2 is illustrated in block diagram form as an exemplary controller 110 connected to the probe rod 68. As will be apparent, the probe rod 68 could be used with other controller designs. The controller 110 includes a digital circuit 112 and an analog circuit 114. The digital circuit 112 includes a digital board 116 including a microprocessor 118 connected to a suitable memory 120 (the combination forming a computer) and a display and keyboard interface 122. The display interface 122 is used for entering parameters and displaying user and status information. The memory 120 comprises both non-volatile memory for storing programs and calibration parameters, as well as volatile memory used during level measurement. Although not shown, the digital board 116 incudes conventional interface circuits for connecting to a remote power source and that utilizes loop control and power circuitry which is well known and commonly used in process instrumentation. The interface circuits control the current on a two-wire line in the range of 4-20 mA which represents level or other characteristics measured by the probe 42. Other interface circuits could be used.

The digital board 116 is also connected to the analog circuit 114 which includes the pulse circuit 58 which is connected to the probe rod 68. The controller 110 includes ETS circuits which convert real time signals to equivalent time signals, as is known.

Guided wave radar combines TDR, ETS and low power circuitry. TDR uses pulses of electromagnetic (EM) energy to measure distance or levels. When a pulse reaches a dielectric discontinuity then a part of the energy is reflected. The greater the dielectric difference, the greater the amplitude of the reflection. In the measurement instrument 20, the probe 42 comprises a wave guide with a characteristic impedance in air. When part of the probe 42 is immersed in a material other than air, there is lower impedance due to the increase in the dielectric. When the EM pulse is sent down the probe it meets the dielectric discontinuity, a reflection is generated.

ETS is used to measure the high speed, low power EM energy. The high-speed EM energy (1000 foot/microsecond) is difficult to measure over short distances and at the resolution required in the process industry. ETS captures the EM signals in real time (nanoseconds) and reconstructs them in equivalent time (milliseconds), which is much easier to measure. ETS is accomplished by scanning the wave guide to collect thousands of samples. Approximately eight scans are taken per second.

The general concept implemented by the ETS circuit is known. A pulse circuit generates hundreds of thousands of very fast pulses of 500 picoseconds or less rise time every second. The timing between pulses is tightly controlled. The reflected pulses are sampled at controlled intervals. The samples build a time multiplied “picture” of the reflected pulses. Since these pulses travel on the probe 42 at the speed of light, this picture represents approximately ten nanoseconds in real time for a five-foot probe. The pulse circuit converts the time to about seventy-one milliseconds. As is apparent, the exact time would depend on various factors, such as, for example, probe length. The largest signals have an amplitude on the order of twenty millivolts before amplification to the desired amplitude by common audio amplifiers. The controller converts timed interrupts into distance. With a given probe length the controller can calculate the level by subtracting from the probe length the difference between a fiducial reference and level distances. Changes in measured location of the reference target can be used for velocity compensation, as necessary or desired.

A “pulse” excitation signal is commonly used in guided wave radar systems. With pulse excitation and equivalent time sampling the received signal produces an echo waveform that displays changes or transitions only in the transmission line (probe) impedance it is measuring. Pulse excitation cannot tell the absolute impedance (50, 55, 60 ohms etc.) of the transmission line it is measuring.

“Step” excitation is a signal that “steps” from one voltage level and stays at that level for a time period greater than the total measurement time of the system (several hundred nanoseconds). After this time, the voltage returns to its original level, and after a delay, the step signal repeats. The reflected signal processing is the same as with pulse excitation; equivalent time sampling techniques are used to detect the reflected signal on an expanded time scale.

The important difference between pulse vs. step excitation is that while pulse excitation only produces a waveform indicative of impedance changes along the probe, step excitation produces a waveform much more indicative of the actual transmission line impedance along the probe. That is, the detected waveform recovered from step excitation can be used to estimate the actual, true impedance along the probe.

In the illustrated embodiment, there are two TDR circuits. One is for the top-down signal and the other is for the bottom-up signal. The waveforms are sent from the analog circuit 114 to the digital board 116 in the control housing 52.

The block diagram in FIG. 6 illustrates the analog circuit 114. The pulse circuit 58 includes first and second TDR front end transmit circuits 124 and 126, and first and second receiver/detector circuits 128 and 130. The first transmit circuit 124 and the first receiver/detector circuit 128, together referred to herein as a first excitation circuit, are connected to a top end of the probe rod 68 for top-down measurement. The second transmit circuit 126 and the second receiver/detector circuit 130, together referred to herein as a second excitation circuit, are connected to a bottom end of the probe rod 68 for bottom-up measurement. The transmit circuits 124 and 126 comprise step excitation generators which drive the probe rod 68 through a driving impedance. The receiver circuits 128 and 130 comprise reflection measurement devices which receive the reflected waveform signals from the probe rod 68. The reflected waveform signals from the receivers 128 and 130 are input signals to respective baseband amplifiers 132 and 134. The amplifiers 132 and 134 provide the analog waveforms to the digital board 116 which digitizes the waveforms. The digital board 116 controls a selector 136 which alternately operates the transmit circuits 124 and 126. As a result, the digital board 116 first digitizes a full waveform from the top end, and then a full waveform from the bottom end. The digital board also controls a TDR ramp and delay locked loop (DLL) generator 138, which sweeps the Receiver/Detector sampling pulse with respect to the TX circuit signal.

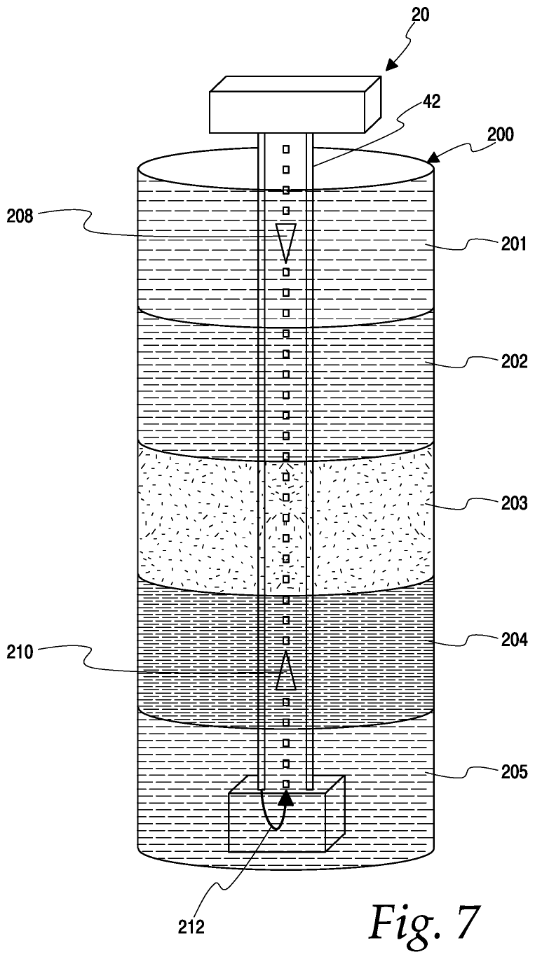

FIG. 7 shows a diagram of the transmitter 20 mounted with the probe 42 extending into a fluid tank 200, filled with exemplary material layers 201, 202, 203, 204 and 205. The transmitter 20 sends an electrical step excitation signal 208 down the transmission line comprised of the probe rod 68 and ground rods 70, 72, 74 and 76, See FIGS. 3-5, and alternately sends an electrical step excitation signal 210, via connection 212, as described above. In the exemplary illustration layer 201 is air, layer 202 is a hydrocarbon, layer 203 is a hydrocarbon emulsified with water, layer 204 is water, and layer 205 is sand submerged in the water. The transmitter 20 uses the methodology in US Applicant's U.S. Pat. No. 9,546,895, the specification of which is incorporated by reference herein, to profile the impedance down through materials 201, 202, and 203. As described herein, the controller 110 adds the information from the bottom-up TDR to profile the impedance up through the material layers 205, 204, and 203. As will be apparent, one or more of the layers 201-205 may not be present.

The software algorithm used therein and in the present application to perform this compensation on an emulsion is called TDR inversion. This method takes a TDR waveform as produced by the instrument and mathematically converts it into N small segments consisting of transmission line models built as equivalent sections of R (resistance), L (inductance) and C (capacitance). The model produces the equivalent of electrical length for each segment, thereby allowing conversion of the waveform into actual length vs. impedance data.

A summary of how the device works is as follows: 1. Obtain waveform scan of tank via TDR (probe impedance vs. time); 2. Use TDR Inversion software technique to transform TDR curve into impedance vs. actual distance; 3. Convert this curve into effective dielectric vs. distance; and 4. Convert curve into percent of oil/water vs. distance. In accordance with the invention, the controller profiles a section of waveform from each of the two excitation circuits and combines the information to determine positions of layers of fluids in a tank. The first excitation circuit provides information about the interface from air 201 into the first fluid layer 202, and from the first layer 202 to the second layer 203. The second excitation circuit provides information about the interface between the fourth layer 204, which is typically water, and the layer above 203, typically an emulsion of water and the upper layers. As is apparent, the information can be used differently in the controller 110.

U.S. Pat. No. 4,774,680 discusses water-in-oil versus oil-in-water emulsions. It shows that two emulsions with the same percent fluids can have drastically different dielectric constants. This patent also shows that this occurs at an indeterminate area around fifty percent water. As a result, the algorithm in Applicant's U.S. Pat. No. 9,546,895 requires additional information to estimate the true percent water much beyond the fifty percent area. The methodology described herein avoids that problem, and simply assumes what is on the bottom is water, and finds the level where there is some material other than water, whether that be an oil-in-water or water-in-oil emulsion.

Because oil has a much lower dielectric than water, the water dominates in the fluids' effect on the TDR reflection. This translates to very small TDR voltage differences between pure water and water with, for example, 20% oil emulsified in the water. Since the desired signal is so small, various artifacts like multiple reflections can swamp the desired signal.

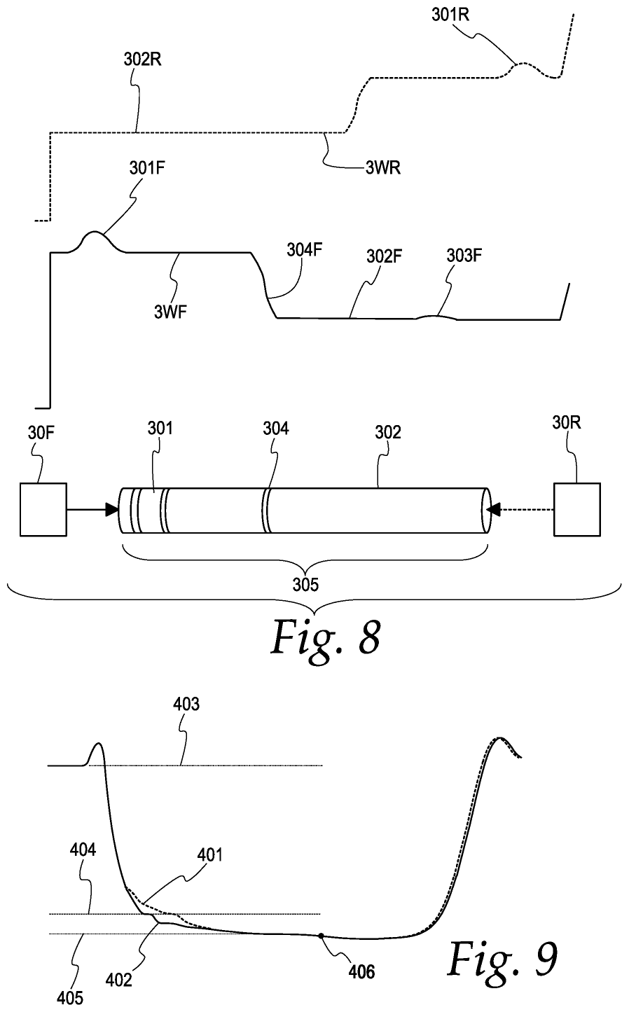

FIG. 8 illustrates a basic simulation of lossless transmission line segments. Therefore, all the waveform features are from simple reflections. This approach shows how some TDR waveform features are due to impedance variations in the transmission line, and some are due to multiple reflections. The methodology in U.S. Pat. No. 9,546,895 is able to sort those two effects, but not perfectly. Down near the probe-bottom, there is water, and an algorithm is looking to find the smallest amount of oil in that water. As discussed above, the oil produces a very small difference in the TDR voltage waveform. FIG. 8 illustrates that a multiple reflection can provide signals that look like dielectric changes but are not.

In FIG. 8 a forward TDR step generator 30F is connected to a transmission line 305, resulting in measured waveform 3WF. Transmission line segment 301 produces TDR waveform segment 301F, and transmission line segment 302 produces TDR waveform segment 302F. Even though transmission line segment 302 is a long ideal transmission line segment, the waveform shows TDR waveform segment 303F. This waveform segment 303F may be interpreted as meaning there is an impedance variation in transmission line segment 302, but waveform segment 303F is due to multiple reflections. In this case, waveform segment 303F is the result of multiple reflections between the impedance discontinuity 304, which creates TDR step 304F, and segment 301 which creates pulse 301F.

A reverse TDR step generator 30R is connected to the transmission line 305, resulting in measured waveform 3WR. Segment 302 leads to TDR waveform segment 302R which is flat. The segment 301 reflection comes much later in time, and so cannot affect the segment 302 response when using the bottom-up method described herein.

Thus, as is apparent, using a TDR signal from both directions eliminates the issue of multiple reflections interference in finding the small oil in water signal. The flat segment 302R response is valuable, since small deviations are easy to see in a known flat signal.

Applicant's US Publication US20190257935 describes using a bottom-up connection to look for motion in the TDR waveforms. That method relies on the TDR signal down in the water to be completely tranquil, even when fluids above are moving. The FIG. 8 analysis shows that multiple reflections from movement up high causes the TDR voltages to move down low, even when the fluids down low are tranquil. The teachings of Applicant's U.S. Pat. No. 9,546,895 could theoretically eliminate the multiple reflections, but any errors in that method leave an interfering signal. The long flat section 302R in FIG. 8 illustrates that the method described herein effectively eliminates the interference of multiple echoes down in the water layer.

The application illustrated in FIG. 1 has sand mixed in the incoming fluids, and the sand slowly precipitates out and begins to cover the probe-bottom. The bottom-up waveform is useful to detect that sand. In FIG. 9 a waveform 402 is a bottom-up waveform with no sand, and a waveform 401 is a bottom-up waveform with sand. The sand-detection method assumes there is water up to point 406 and creates a horizontal cursor 405 representing the water. The method creates another horizontal cursor 403 representing a 50-ohm impedance reference. A threshold 404 is set at an adjustable point between the two horizontal cursors. The time at which the waveform crosses the threshold 404 can be calibrated to represent the sand depth. The bottom-up connection in this patent is what enables the probe to locate the sand with a simple algorithm.

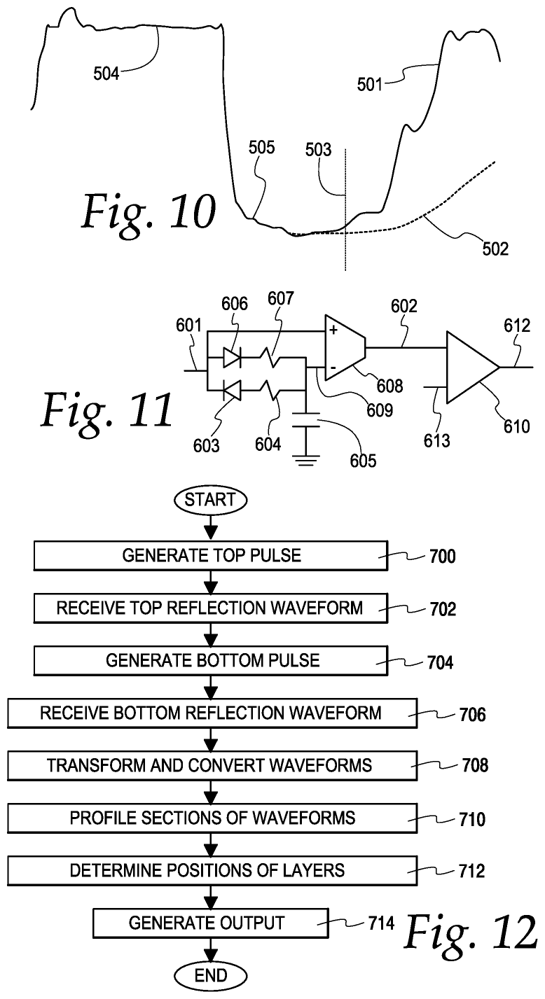

FIG. 10 illustrates a method to locate an emulsion floating on water. A waveform 501 is a typical bottom-up waveform, with emulsion and oil floating on water. Applicant's U.S. Pat. No. 9,360,361 describes use of a coating on the probe which can be used as the coating 78 in FIG. 4. This coating enables the TDR waveforms to penetrate through water without excessive losses. Even with the coating, the TDR waveform has a downward slope. This can be seen by comparing waveform section 504, corresponding to a 50-ohm cable, to section 505, corresponding to water. The section 505 has a downward slope, which is due to the water's lossy dielectric. The waveform 501 is decreasing to the left of a vertical cursor 503 and rises after that point. Cursor 503 marks the point where the slope deviates from the pure water to emulsion.

The method to find the cursor 503 is to maintain a waveform 502, a fast-decay slow-attack filtered version of the waveform 501. FIG. 11 illustrates a circuit diagram which serves as a block diagram for the controller 110. In accordance with the invention this circuit is implemented in software in the microprocessor 118. An input signal line 601 is connected to a + input of a summer 608 and to diodes 606 and 603. The diode 606 is connected via a resistor 607 to a signal line 609 which is connected to the − input of the summer 608. The diode 603 is connected via a resistor 604 to the signal line 609. A capacitor 605 connects the signal line 609 to ground. The output of the summer 608 on a line 602 is connected to a + input of a comparator 610 having an input threshold 613 at a − input. The output of the comparator 610 is on a line 612.

The diodes 606 and 607 are ideal since they are simple “if” statements in software. It can be seen that the signal on the 609 follows the input signal on the line 601, with some RC lag. Furthermore, when the signal 601 is above the signal 609, the lag is the resistor 607 and the capacitor 605, and when the signal 601 is below the signal 609, the lag is the resistor 604 and the capacitor 605. In this design, the resistor 607 is much greater than the resistor 604, so that the signal 609 follows the signal 601 downwards, but when the signal 601 deviates upwards, the signal 609 lags behind. The difference operation in the summer 608 sends the distance between 601 and 609 to the comparator 610, which then sets the signal 612 high when the difference exceeds the threshold 613. The threshold is used by the microprocessor 118 to find the cursor 503 of FIG. 10 and thus the location of the emulsion on the water.

FIG. 12 illustrates a flow diagram of the software in the controller 110 for emulsion measurement. The first excitation transmit circuit 124 connects to the top of the probe 68 and generates downward travelling step excitation signals on the transmission line at a block 700 and receives a reflected signal from the transmission line via the receiver 128 at a block 702. The second excitation transmit circuit 126 is connected to the bottom of the probe 68 generates upward travelling step excitation signals on the transmission line at a block 704 and receives a reflected signal from the transmission line via the receiver 130 at a block 706. Each reflected signal comprises a waveform of probe impedance over time. The microprocessor 118 transforms the waveforms into impedance relative to distance and converts the transformed waveforms into effective dielectric relative to distance at a block 708. The controller then profiles sections of the waveforms from each of the two excitation circuits at a block 710 and combines the information to determine positions of layers of fluids in a tank at a block 712. The first excitation circuit provides information about the interface from air into the first fluid layer, and from the first layer to a second layer. The second excitation circuit provides information about the interface between the lowest layer, which is typically water, and the layer above, typically an emulsion of water and the upper layers, as discussed above. The controller generates an output representing the determined levels at a block 714.

Thus, as described herein, the guided wave radar probe is used for measuring levels in tanks where multiple layers of fluids can exist and uses both top-down and bottom-up measurement signals.

It will be appreciated by those skilled in the art that there are many possible modifications to be made to the specific forms of the features and components of the disclosed embodiments while keeping within the spirit of the concepts disclosed herein. Accordingly, no limitations to the specific forms of the embodiments disclosed herein should be read into the claims unless expressly recited in the claims. Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

As is apparent, the functionality of the analog circuits, could be implemented in the microprocessor 118, or any combination thereof. Accordingly, the illustrations support combinations of means for performing a specified function and combinations of steps for performing the specified functions. It will also be understood that each block and combination of blocks can be implemented by special purpose hardware-based systems which perform the specified functions or steps, or combinations of special purpose hardware and computer instructions.

1. A three phase guided wave radar measurement instrument for measurement of an emulsion comprising a hydrocarbon layer, an emulsion layer and a water layer, comprising:
a probe defining a transmission line, the probe comprising a process connection for mounting to a process vessel, an elongate rod extending downward from the process connection to extend into a process liquid, a top connector at a top end of the elongate rod, and a bottom connector at a bottom end of the elongate rod;
a top excitation circuit connected to the probe top connector for generating excitation signals on the transmission line and receiving a reflected signal from the transmission line, the reflected signal comprising a top-down waveform of probe impedance over time;
a bottom excitation circuit connected to the probe bottom connector for generating excitation signals on the transmission line and receiving a reflected signal from the transmission line, the reflected signal comprising a bottom-up waveform of probe impedance over time; and
a controller operatively connected to the top excitation circuit and the bottom excitation circuit, the controller alternately operating the top excitation circuit and the bottom excitation circuit and profiling content of the emulsion responsive to analysis of the top-down and bottom-up waveforms to determine interface levels between air and the hydrocarbon layer, between the hydrocarbon layer and the emulsion layer and between the emulsion layer and water.

2. The three phase guided wave radar measurement instrument of claim 1 wherein the controller profiles content of the emulsion responsive to analysis of the top-down waveform to determine interface levels between air and the hydrocarbon layer and between the hydrocarbon layer and the emulsion layer and profiles content of the emulsion responsive to analysis of the bottom-up waveform to determine interface level between the emulsion layer and water.

3. The three phase guided wave radar measurement instrument of claim 2 wherein the controller converts the waveforms to dielectric value over distance.

4. The three phase guided wave radar measurement instrument of claim 3 wherein the controller profiles sections of the waveforms to determine the interface levels.

5. The three phase guided wave radar measurement instrument of claim 2 wherein analysis of the bottom-up waveform to determine interface level between the emulsion layer and water comprises comparing the bottom-up waveform to a filtered version of the bottom-up waveform.

6. The three phase guided wave radar measurement instrument of claim 5 wherein interface level between the emulsion layer and water is determined responsive to location where difference between the bottom-up waveform and the filtered version of the bottom-up waveform exceeds a select threshold.

7. The three phase guided wave radar measurement instrument of claim 5 wherein the bottom-up waveform is analyzed to determine sand depth in the water layer.

8. A guided wave radar measurement instrument comprising:
a probe defining a transmission line, the probe comprising a process connection for mounting to a process vessel, an elongate rod extending downward from the process connection to extend into a process liquid, a top connector at a top end of the elongate rod, and a bottom connector at a bottom end of the elongate rod;
a top excitation circuit connected to the probe top connector for generating excitation signals on the transmission line and receiving a reflected signal from the transmission line, the reflected signal comprising a top-down waveform of probe impedance over time;
a bottom excitation circuit connected to the probe bottom connector for generating excitation signals on the transmission line and receiving a reflected signal from the transmission line, the reflected signal comprising a bottom-up waveform of probe impedance over time; and
a controller operatively connected to the top excitation circuit and the bottom excitation circuit, the controller alternately operating the top excitation circuit and the bottom excitation circuit and profiling content of the emulsion responsive to the waveforms by transforming the waveforms into impedance relative to distance, converting the transformed waveforms into effective dielectric relative to distance, determining mixture content of the emulsion at select distances responsive to the effective dielectric at the select distances and developing an output representing mixture content relative to level units.

9. The guided wave radar measurement instrument of claim 8 wherein the controller profiles content of the emulsion responsive to analysis of the top-down waveform to determine interface levels between air and first layer and between the first layer and a second layer and profiles content of the emulsion responsive to analysis of the bottom-up waveform to determine interface level between the second layer and a third layer.

10. The guided wave radar measurement instrument of claim 9 wherein the controller converts the waveforms to dielectric value over distance.

11. The guided wave radar measurement instrument of claim 10 wherein the controller profiles sections of the waveforms to determine the interface levels.

12. The guided wave radar measurement instrument of claim 9 wherein analysis of the bottom-up waveform to determine interface level between the second layer and the third layer comprises comparing the bottom-up waveform to a filtered version of the bottom-up waveform.

13. The guided wave radar measurement instrument of claim 12 wherein interface level between the second layer and third layer is determined responsive to location where difference between the bottom-up waveform and the filtered version of the bottom-up waveform exceeds a select threshold.

14. The guided wave radar measurement instrument of claim 8 wherein the probe comprises a coated probe.

15. A radar transmitter for emulsion measurement comprising:
a probe defining a transmission line for sensing impedance, a first excitation circuit connected to a top of the probe for generating downward travelling excitation signals on the transmission line and receiving a reflected signal from the transmission line, and a second excitation circuit connected to a bottom of the probe for generating upward travelling excitation signals on the transmission line and receiving a reflected signal from the transmission line, each of the reflected signals comprising a waveform of probe impedance over time; and
a controller operatively connected to the excitation circuits, the controller profiling a section of waveform from each of the excitation circuits and combining information on the sections to determine positions of layers of fluids in a tank, wherein the first excitation circuit provides information about an interface from air into a first fluid layer, and from the first layer to a second layer, and the second excitation circuit provides information about an interface between a lowest layer and the second layer.

16. The radar transmitter of claim 15 wherein the probe comprises a coated probe.

17. The radar transmitter of claim 15 wherein the controller converts the waveforms to dielectric value over distance.

18. The radar transmitter of claim 17 wherein the controller profiles sections of the waveforms to determine the interface levels.

19. The radar transmitter of claim 16 wherein analysis of the waveforms to determine interface level between the second layer and the lowest layer comprises comparing the waveform from the second pulse circuit to a filtered version of the waveform from the second pulse circuit.

20. The radar transmitter of claim 19 wherein interface level between the second layer and lowest layer is determined responsive to location where difference between the waveform from the second pulse circuit and the filtered version of the waveform from the second pulse circuit exceeds a select threshold.
